(19) United States
(12) Patent Application Publication
(10) Pub. No.: US 2007/0272323 A1
(43) Pub. Date: Nov. 29, 2007

(54) Flexible Container Suitable for Paint

(75) Inventor: Bernard Verhaeghe, Nazareth (BE)

Correspondence Address: BROWDY AND NEIMARK, P.L.L.C.;624 NINTH STREET, NW, SUITE 300, WASHINGTON, DC, 20001-5303, US

(73) Assignee: Flexi-Cup, Nazareth (BE)

(21) Appl. No.: 11/631,320

(22) PCT Filed: Jul. 4, 2005
(86) PCT No.: PCT/BE05/00107

§ 371 Date: Jan. 3, 2007

(30) Foreign Application Priority Data
Jul. 2, 2004 (EP) 04447160.5

(51) Int. Cl. B05B 7/24

(52) U.S. Cl. 141/20.5; 141/114

(57) ABSTRACT

The present invention relates to a container suitable for holding paint or a similar fluid, to be sprayed with the aid of a spraying device, which container comprises a closed bottom and a circumferential wall, which at its under side is closed by the bottom and at its upper side comprises attachment means for detachably connecting to a lid, onto which container a spraying gun can be mounted, and is characterized in that the container is easily collapsible and the attachment means comprise a stiff raised rim, comprising first gripping means which can cooperate with second gripping means present on the lid.

The invention relates to a container suitable for application in a spraying device for fluids such as for instance paint, which container is provided with a circumferential wall with an upper- and a lower end, a bottom wall which closes the container at the under side of the circumferential wall, and attaching means for detachably connecting to a lid onto which a spraying gun can be mounted.

Such a container to be used in spraying devices for spraying surfaces is for example known from WO-A-0112337. The container described in WO-A-0112337 is made of a stiff polymer, with an external screw thread at the upper end of its circumferential wall. Onto this external screw thread a lid is screwed to close the container, which lid is provided with a collar with internal screw thread. The lid at its upper side is provided with an opening, which can receive a coupling piece for attachment to a spraying gun. The coupling piece is provided at the spraying gun side with an internal screw thread onto which the inlet part of the spraying gun can be attached.

From U.S. Pat. No. 6,752,179 a container is known, which is suitable for holding paint or a similar fluid, to be sprayed with the aid of a spraying device. The container comprises a collapsible circumferential wall, having a first closed end wall at a first end. At a second end opposite the first end, attachment means are provided for detachably connecting to a lid onto which a spraying gun can be mounted. The attachment means comprise a stiff raised rim, extending substantially parallel to the circumferential wall of the container. The rim comprises a lower surface which is provided to co-operate with gripping means present on the lid.

FR-A-2.669.306 discloses a container made of a stiff material, into which a collapsible liner is mounted, the liner being provided for containing medical drugs. Into a rim surrounding the top edge of the liner, a pump is received, which is attached within the top rim by means of an external ring. The pump is provided for dosing the drug contained in the liner, through an outlet in the ring. The container is closed at its bottom. The upper side of the container comprises an upright rim surrounding part of the pump and the outlet. The rim is provided to co-operate with lid.

JP-A-6335643 discloses a container for containing a spraying liquid, which is attachable/detouchable from a disposable cup, in which the container is received. The cup is closed off by a cap, which comprises a downwardly protruding rim extending around a top edge of the cup. The top edge of the container is sealed into the space between the top edge of the container and the cap.

The known spraying device for spraying paint in particular comprises the known container for holding the paint, a spraying gun connectable to the lid, and a compressed air line, attachable onto the spraying gun. The known container is provided with a level indication onto its circumferential surface such that quantities of different paint can be mixed in the container. After the container has been filled with paint it is closed with the lid, and the spraying gun is screwed upside down onto the lid. After connecting the compressed air line to the spraying gun, the spraying gun is taken in hand, thereby positioning the container filled with paint on top of the spraying gun with its outlet opening pointing downward. Because of this particular position of the container during use, the paint to be sprayed flows into the spraying gun under the action of gravity. By activating the spraying gun, the paint is subsequently, preferably under the pressure of the compressed air, atomized through the nozzle of the spraying gun onto the surface to be treated, where it deposits.

When emptying the container a constantly increasing volume of air is created in the container upstream from the paint, in which therefore the pressure constantly decreases. This prevents the paint from streaming out freely. To prevent the formation of a vacuum in the air volume upstream from the paint when in use, the circumferential wall of the known container is provided with an opening at bottom surface height, which is sealable through a pin. When filling the container with paint the opening is sealed. As soon as the container is positioned in reverse position onto the spraying gun, the pin has to be removed to allow for air supply upstream of the paint during spraying.

Repeatedly having to seal and reopen the known container is time consuming and can easily lead to mistakes, for instance when the operator forgets to close the container. Moreover the sealable opening can easily become obstructed with paint. Also there is a danger for leakage, for instance when low viscous liquids such as primers and similar fluids are sprayed.

To decrease the risk for leakage and prevent frequent cleaning of the known container it has been proposed in WO-A-9832539 to provide the mixing container with a removable polymeric liner with very thin wall. This liner is placed into the known container where after the container is filled with the fluid to be sprayed. The container provides for sufficient support, for instance during filling with paint. After the container has been emptied through the spraying operation the liner is removed from the container and discarded. Although the use of a liner solves the problem of possible leakage in the known container, its circumferential wall still needs an opening to prevent formation of vacuum. Indeed, since the liner has a very thin wall thickness, it more or less follows the decreasing mass of paint in the container. Because of this, an increasing volume of air is again created upstream from the out flowing paint, thereby creating a vacuum between the liner and the container.

A typical paint job, such as is for instance carried out in the automotive industry comprises applying several layers on top of each other. It is customary among other things to first apply a grounding layer, thereafter one or more coloring layers, and finally one or more finishing layers. It is therefore of great importance to be able to change as quickly as possible from one container upon its emptying to another container, if desired filled with the same paint—in case the surface is not treated completely yet—, or with other fluids, such as for instance a primer or finishing varnish, when a new layer should be applied.

A great disadvantage of the known container such as described in WO-A-9832539 is that it is only very laboriously replaced and/or filled. In the known spraying device, the polymeric liner with small wall thickness is detachably clamped between the stiff container and the lid by means of a separate coupling piece in the form of a collar, which is screwable onto the outer cup. The coupling piece thereby connects the lid, the liner and the stiff mixing cup with each other. These known attaching means for the liner are complex, and comprise many parts, which make placement and removal of the liner after use time consuming.

The invention aims to provide a container to be used in a spraying device as such, without an additional cup containing the container when mounted to the spraying device, which container is liquid tight, easily and expediently replaceable and easily filled with fluid to be sprayed, and which allows a substantially undisturbed outflow of the fluid contained therein.

The container according to the invention is thereto characterized in that the attachment means comprise a stiff raised rim, comprising first gripping means which are provided to cooperate with second gripping means present on the lid, in that the container is easily collapsible, in that the upper side of the circumferential wall of the container is bend into a tightening rim, in that the stiff raised rim comprises a first and a second part, which first part extends substantially parallel to the circumferential wall of the container, and which second part forms a tightening rim, which is provided to impinge onto the tightening rim of the circumferential wall of the container, in that the first gripping means for the lid are provided on an inner side of the first part of the stiff raised rim, and in that the first gripping means of the stiff raised rim extend above the tightening rim of the circumferential wall in the connected position of the lid and the container. The container is to be mounted to a spraying gun in the absence of an external cup for receiving the container.

In the context of this invention the terminology easily collapsible is meant to designate a container wall, which during normal use of the spraying device may relatively easy deform upon the outflow of the fluid contained therein, such that the outflow of the fluid is not hindered appreciably. This property may be achieved in a known manner by the person skilled in the art through proper selection of the material of the container wall, and of the thickness of the container wall. Because the container is, according to the invention, at upper end height of the circumferential wall provided with attaching means in the form of a stiff, raised circumferential rim, a container is obtained which is on the one hand easily collapsible, but on the other hand has sufficient stiffness and form stability that it may be filled unsupported.

Another advantage of the flexible container according to the invention is that the separate coupling piece needed in the known stiff container to couple the container to the mixing cup, when using a disposable liner, is no longer necessary. This offers the additional advantage of being able to remove the container according to the invention quickly and simply from the lid of the spraying device, which enhances productivity. In this way refilling of the container may now be carried out much simpler than known hitherto. It is likewise possible to apply containers, previously filled with paint or other fluids without waste of time. For instance, in case residue of a previous paint is still present in the container, in the lid and/or in the spraying gun, it is now possible to spray a cleaning fluid and/or a solvent in between different paint layers without loosing much time, in order to remove this residue.

The thin-walled liner of the known stiff container has to deform during the spraying operation in such a way that the opening in the circumferential wall of the stiff container is not sealed off. The container according to the invention does not have this disadvantage. It is indeed possible to allow the container walls to collapse such that the bottom surface of the container during spraying of the paint moves along with the paint downstream from it. It is likewise possible to allow the container walls to collapse such that the bottom surface essentially remains on the same height but the bottom surface and/or circumferential walls collapse in radial direction. It is also possible to allow only parts of the walls to collapse.

Advantageously, the container according to the invention is characterized in that the circumferential wall of the container is provided with at least one local outwardly and/or inwardly bulged out wall part, whereby this part extends along an essentially closed circumferential contour line in a plane substantially parallel to the bottom surface.

By this is achieved that the collapsing behavior of the circumferential wall of the flexible container during spraying is facilitated. Also it becomes possible in this way to increase the stiffness and stability when the container is arranged freestanding to be filled. By choosing the wall thickness changes judiciously it also becomes possible to facilitate readapting the substantially original shape after the container has been emptied. This also allows reusing the container several times, if desired, before discarding it permanently.

The container according to the invention may be made of every material with sufficient flexibility to be collapsible. Suitable materials are for instance paper, metal foil, rubber and/or polymers. Particularly suitable are polymeric materials. Suitable polymers may for instance be selected from thermosetting (co)polymers such as epoxies, unsaturated polyester resins and so on. Suitable thermoplastic (co)polymers are for instance polyamides (PA), polychlorides such as for instance polyvinyl chloride (PVC), polyolefin's, for instance polypropylene (PP), polyethylene (PE), polytetrafluoroethylene (PTFE), polyphenyleneether (PPE or PPO), and so on, amorphous and/or crystalline polyesters such as polyalkylene terephtalates, for instance polyethylene terephtalate (PETP or PET), polybutylene terephtalate (PBT), etc., or polyimides (PI), such as for instance polyether imide (PEI), polyamide imide (PAI), or polymethyl(meth)acrylate (PMMA), polyether methacrylate (PEMA), and polycarbonates. Suitable transparent polymers are selected from the amorphous polymers of the above-mentioned list.

A particularly suitable polymer for manufacturing the container is polyethylene or polypropylene with low density. Such polymers are easily processable into thin walled products, for instance by processing methods known per se, such as injection molding, vacuum forming and/or blow molding. The stiff upstanding rim may likewise be made of a polymer, for instance of high-density polyethylene by means of injection molding.

The container according to the invention may be made by means of all processing methods for polymers available to the man skilled in the art. It is for instance possible to manufacture the container by means of injection molding, thermoforming, blow molding, and/or combinations of said processing methods, such as for instance injection blow molding. When using injection blow molding, a preform of the container is first made by injection molding, where after the preform is shaped into the final product form by means of blow molding. A particularly suitable process for manufacturing the container according to the invention is thermoforming. In this process a polymer film is sucked against a mould wall in the shape of the formable product by applying an underpressure. This usually happens at temperatures between the glass transition temperature and the melting- or softening temperature of the polymer.

The container of flexible material according to the invention is advantageously characterized by the fact that the local, outwardly and/or inwardly bulged out part has a lower wall thickness than the wall thickness of the rest of the circumferential wall.

Hereby is achieved that the collapsing behavior can be controlled in the desired manner, whereby the manufacture of the container is in addition simplified. It is for instance possible to manufacture the container with local wall thickenings by means of blow molding.

The wall thickness of circumferential wall, bottom wall and local wall thickenings of the container according to the invention have to be selected such that the desired collapsing behavior and stability are achieved. Suitable wall thicknesses for the polymeric circumferential wall and bottom are for instance selected between 50 and 800 μm. More suitable are wall thicknesses between 250 and 500 μm. Particularly suitable polymeric wall thicknesses are between 300 and 400 μm. The local wall thickenings in the circumferential wall preferably have a maximal thickness between 250 and 1000 μm. More preferably this is between 500 and 800 μm. Particularly suitable are local wall thickenings with thicknesses between 600 and 700 μm.

Preferably the container according to the invention is essentially transparent and the local inwardly and/or outwardly bulged out wall parts are divided over the height of the circumferential wall such that they form a level indication for the volumetric amount of fluid, to be held in the container.

In the known container an eventual level indication is always applied onto the stiff outer beaker by means of for instance printing ink. Applying a level indication in printing ink onto the flexible liner of the known container is impossible since this level indication depends on the shape of the flexible liner. This shape is variable because the liner has a low wall thickness. By providing a level indication, which coincides with a local outwardly and/or inwardly bulged out wall part, the use of printing ink is prevented. In the same manner the shape of the flexible container is stabilized, thereby providing a reliable level indication.

In principle the volume of the container according to the invention is not limited in size. Suitable volumes are generally between 200 and 1500 ml for practical reasons, but smaller of larger volumes are possible. Evidently the amount of circumferential rings, which together form the level indication, may be selected depending on the desired volume of the container, and the desired accuracy of the reading.

To illustrate the invention, some preferred embodiments of the container according to the invention will be described below with reference to the figures, without however limiting the invention thereto.

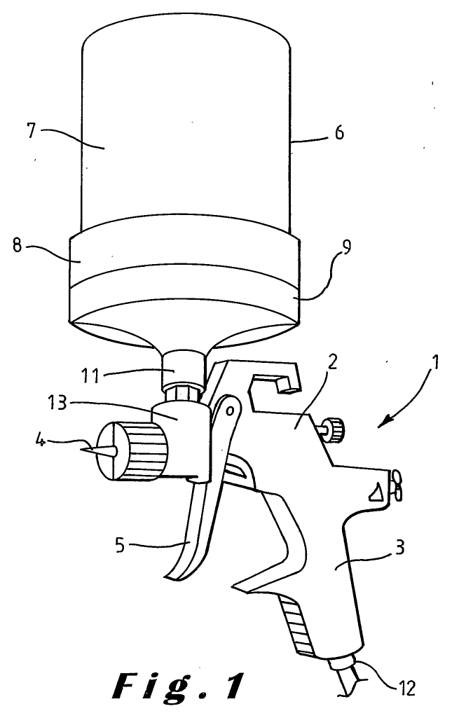

FIG. 1 schematically shows a spraying device consisting of a spraying gun, and a lid and container according to the invention.

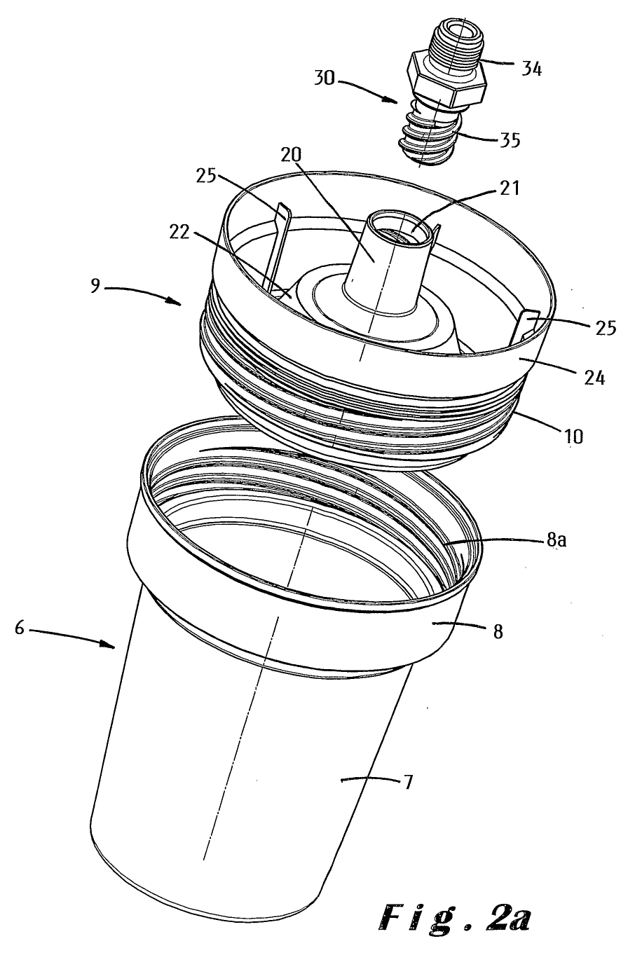

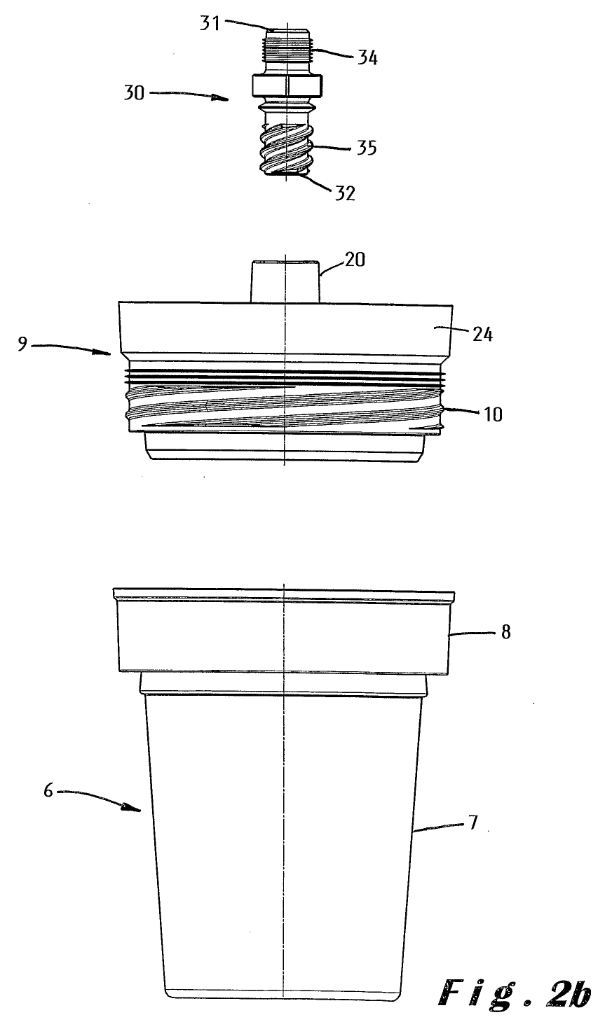

FIG. 2a is a schematic representation in perspective of the container, lid and coupling piece according to the invention.

FIG. 2b is a side view of the schematic representation of FIG. 2a.

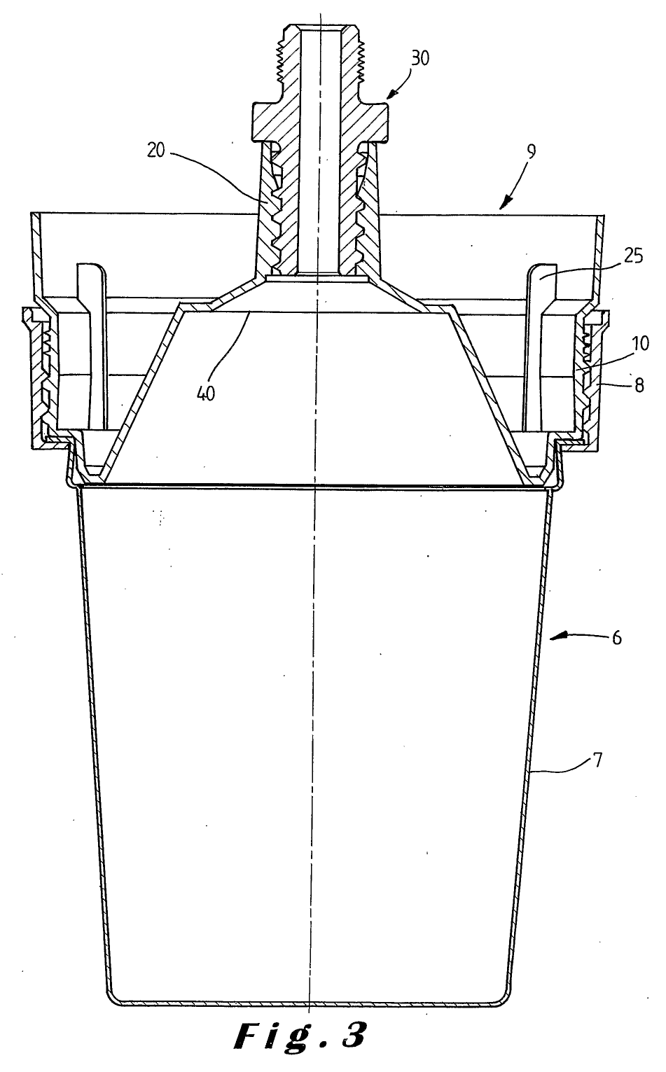

FIG. 3 shows a sectional view of the container with lid of FIG. 2 in assembled state along a vertical symmetric plane.

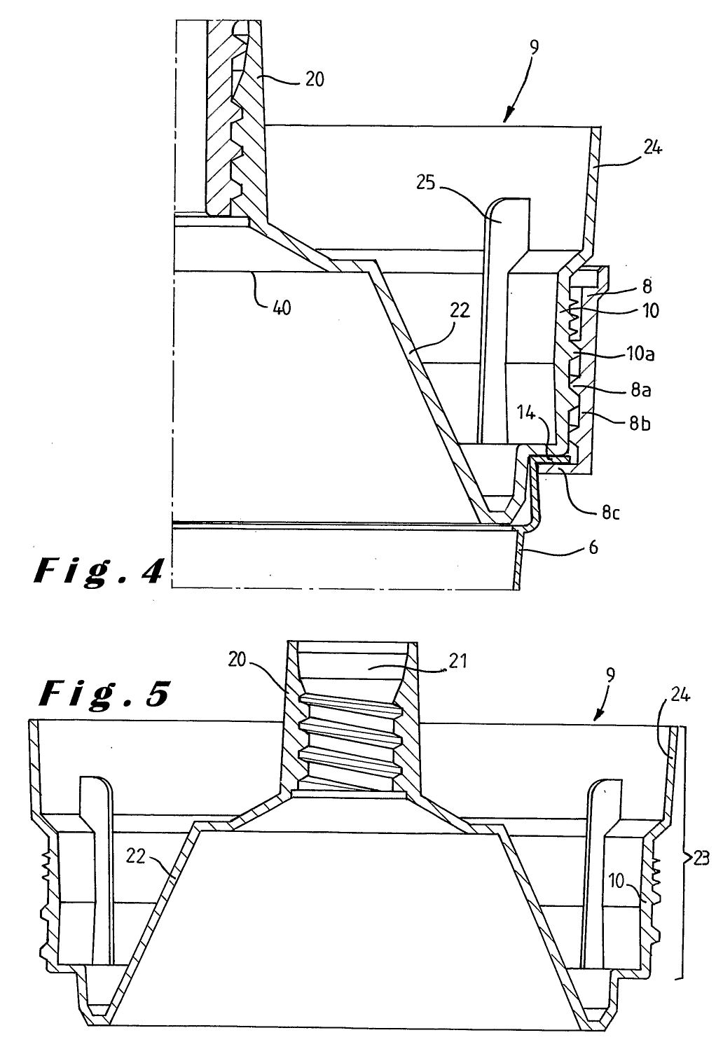

FIG. 4 shows a detailed transversal sectional view of the connection between container and lid.

FIG. 5 shows a transversal sectional view of the lid according to the invention along a vertical symmetric plane.

FIG. 5a depicts a side view of a lid according to the invention.

FIG. 5b shows a transversal sectional view of the lid of FIG. 5a along a vertical symmetric plane.

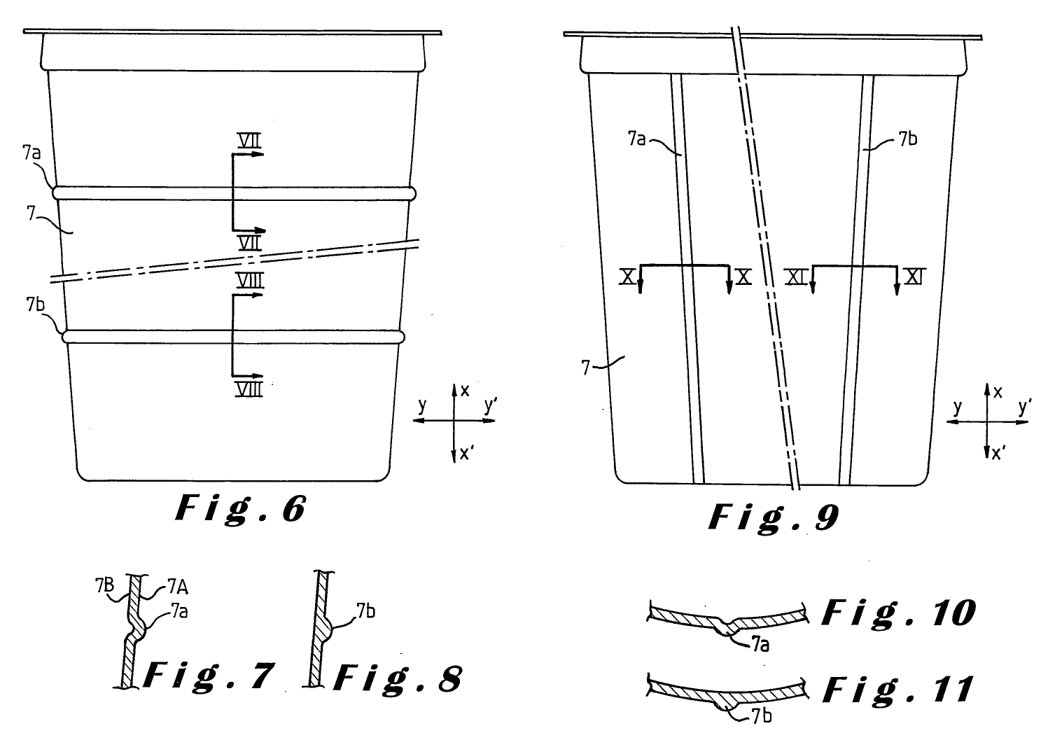

FIG. 6 shows a flexible container according to the invention with circumferential wall thickenings.

FIG. 9 shows a flexible container according to the invention with vertical wall thickenings.

FIG. 7 shows in detail a sectional view along the line VII-VII of a possible embodiment of the local wall thickening.

FIG. 8 shows in detail a sectional view along the line VIII-VIII of a possible embodiment of the local wall thickening.

FIG. 10 shows in detail a sectional view along the line X-X of a possible embodiment of the local wall thickening.

FIG. 11 shows in detail a sectional view along the line XI-XI of a possible embodiment of the local wall.

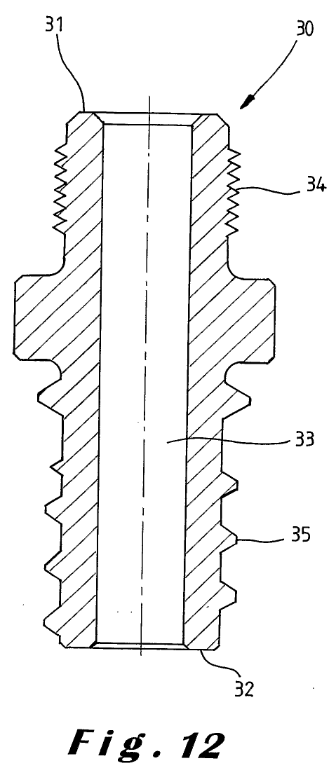

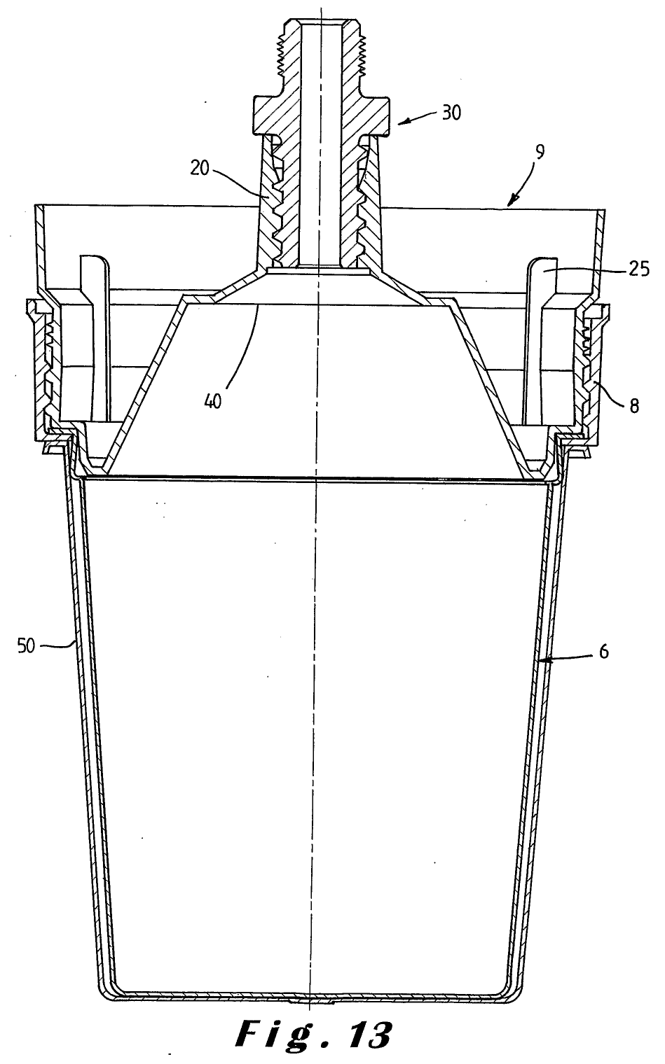

FIG. 12 shows a vertical transversal sectional view of a coupling piece according to the invention.

FIG. 13 is a vertical transversal sectional view of a container according to the invention, supported by an outer beaker to fill it.

In FIG. 1 a spraying gun 1 is shown with a housing 2, a handle 3 and a spray head 4 at the front side. Pulling trigger 5 operates the spraying gun. The container 6 into which the fluid to be sprayed is contained, is during normal operation positioned upside down above the spraying gun 1. Container 6 comprises a collapsible circumferential wall 7 and attachment means in the form of a stiff raised rim 8. The container 6 is attached to the spraying gun 1 by means of a lid 9, provided with a coupling piece 11 for connection to the spraying gun 1. The container 6 is to be used as such without an interfering cup made of a stiff material receiving the container. Container 6 and lid 9 are detachably secured to each other through cooperating attaching means 8a of stiff container rim 8 and attaching means 10 of lid 9. The container 6 interconnects with an internal (not visible) supply line for compressed air for instance, which may be supplied through a connection 12, provided in the handle 3 of spraying gun 1. In use, compressed air is supplied through connection 12 and passed on to spray head 4 upon pulling trigger 5. The compressed air stream entrains the paint or otherwise, running out of container 6 under the influence of gravity, towards spray head 4 where it leaves the spraying gun 1 and atomizes onto the surface to be sprayed.

FIGS. 2a and 2b depict a container 6 according to the invention consisting of an easily collapsible circumferential wall 7 provided with attaching means for a lid in the form of a stiff raised rim 8. Circumferential rim 8 may be manufactured from each suitable material. It is possible to make the rim from metal, stiff cardboard, wood, and/or stiff polymer. A particularly preferred material is a stiff polymer, such as for instance polyethylene and/or polypropylene. A lid 9 seals the container. The lid is provided with attaching means 20 for connection with a spraying gun 1. The attaching means 20 cooperate with a coupling piece 30, which ensures that spraying devices with different types of connection 13 may be attached without problems.

The paint or other fluid to be held by the container 6 is applied to the container 6 in a simple manner by removing lid 9 from the container. The paint is poured into the container through the opening at the upper side of the container. Subsequently lid 9 is reattached to the container. If one leaves the connection between lid 9 and spraying gun 1 through coupling piece 30 intact, one is able to change the paint and/or paint container very expediently. To prevent ingress of undesired particles into the spray head, lid 9 may, if desired, be provided with filter 40. Filter 40 may be removable from lid 9, or may be secured permanently to it. Preferably filter 40 is removable from lid 9. A particularly preferred filter 40 is provided with a stiff circumferential rim, for instance from low-density polyethylene (LDPE). By also providing the lid 9 at the inner side with a circumferential rim, filter 40 may be easily secured to lid 9 by hooking it with its stiff circumferential rim behind the circumferential rim of lid 9. Already manufactured lids and/or filters are easily provided with rims and other details, for instance by joining techniques known per se by the skilled person, such as thermal and/or ultrasonic welding.

The container 6 has first attaching means 8 for connection with corresponding second attaching means 10 of lid 9. The attaching means are provided with first and second gripping means 8a and 10a. The preferred embodiment shown in FIG. 4 has cooperating first and second gripping means 8a en 10a, which form a screw-thread connection. It is likewise possible to use other suitable gripping means. The container according to the invention is preferably characterized in that the cooperating first and second gripping means form a bayonet-catch. In such an embodiment the gripping means 8a form an amount of pins, extending radially outward and arranged along the circumference of the first attaching means 10, whereby each pin may be slid under edges provided onto the second attaching means, by first pushing down the lid such that the pins are aligned in the vertical direction in a lower position than the underside of the edges, and subsequently rotating the lid until the pins become align underneath the edges. It is likewise possible to connect the lid to the container by providing the lid with a slightly larger diameter than the upper side of the circumferential wall of the container, thereby allowing the lid to be received fittingly and more or less tightly by the container.

The stiff raised rim 8 may be attached to the flexible circumferential wall 7 in a number of ways. Preferably the container 6 according to the invention is characterized in that the upper side of the circumferential wall 7 of the container is bend into a tightening rim 14, that the stiff raised rim 8 comprises a first 8b and a second part 8c, which first part 8b extends substantially parallel to the circumferential wall 7 of the container 6, and which second part 8c forms a tightening rim, which can impinge onto the tightening rim 14 of the circumferential wall 7 of the container 6, and that further the first part 8b of the rim 8 comprises the first gripping means 8a for the lid 9, and that these extend at the inner side of the first part 8b. Such a connection between flexible container and lid is on the one hand easily (un)coupled, and on the other hand completely leak proof with respect to the fluid present in the container. The first gripping means of the stiff raised rim extend beyond the tightening rim of the circumferential wall in the connected position of the lid and the container. A lower part of the second gripping means impinge on an upper part or top face of the tightening rim and the first gripping means impinge upon a lower part or bottom face of the tightening rim.

In the preferred embodiment shown in FIG. 4 the connection between tightening rim 8c of the stiff raised rim 8 and the tightening rim 14 of the circumferential wall 7 is not detachable. This connection may for instance be achieved by gluing both parts 8c and 14 onto each other by means of a suitable adhesive. It is also possible to manufacture both parts in one piece, in one processing step. Particularly preferred is an embodiment wherein the stiff raised rim 8 is attached over at least part of its surface to at least part of the upper end of the circumferential wall 7 by means of a welding connection.

According to another more preferred embodiment, the connection between tightening rim 8c of the stiff raised rim 8 and the tightening rim 14 of the circumferential wall 7 is detachable as this facilitates detaching of the lid from the container. To confine the container in a fixed position with respect to the tightening rim 8 and to reduce the risk to leaking, on an outer circumferential wall of the container, at a position below the tightening rim, at least one notch is provided at a distance from the tightening rim which is sufficient to accommodate between the tightening rim and the at least one notch, the second part of the stiff raised rim.

To ensure that the collapsible container has sufficient rigidity to be able to fill it free standing without support, and to ensure that the collapsing of the container during spraying of the paint or other fluid may progress in a controlled and straightforward manner, the flexible container 6 preferably is provided with local outwardly and/or inwardly extending bulged out wall parts 7a, 7b, . . . in the circumferential wall 7, as is shown in FIGS. 6 up to and including 11. As further indicated in FIGS. 6 up to and including 11, these bulged out wall parts may lead to a local wall thickness change (in FIGS. 8 and 11 denoted as 7b), and/or keep the wall thickness essentially unchanged such that the wall is locally buckled with respect to the outer surface 7A and/or the inner surface 7B of the flexible circumferential wall 7. The dotted line in FIGS. 6 and 9 indicates that several forms 7a, 7b of the bulged out wall parts are possible in the same container, but that for reasons of manufacturing ease, flexible containers 6 preferably comprise bulged out wall parts with a form 7a or 7b. It is possible to provide the circumferential wall 7 of container 6 with one or more locally extending, outwardly and/or inwardly bulged out parts. If several of these wall thickness changes 7a, 7b, . . . are provided in the circumferential wall 7 and these extend substantially along a circumferential line more or less parallel to the bottom plane 70, as shown in FIG. 6, these are preferably divided over the height of the container, in order to better control its collapse. It has advantages to let extend the wall thickness changes 7a, 7b, . . . in the circumferential direction in a plane substantially parallel to the bottom plane 70 of the container, as depicted in FIG. 6. In use, the container 6 is first filled with paint, and subsequently closed with the aid of lid 9 and connected to a spraying gun 1 through attaching means 11 and coupling piece 30. The spraying gun 1 with container 6 and lid 9 attached thereto, is subsequently turned around to place it into its position of operation, as shown in FIG. 1. During spraying of the paint, the paint is sucked from the container 6 by which the walls 7, 70 of the container will collapse as a result of the decreasing pressure in the container 6. The collapsing behavior has to be such that the outflow of the paint is not hindered, for instance because parts of the container separate from the outflow opening 11 to the spraying gun 1. It would have great advantages if the collapsing behavior could be made more or less independent from the angle at which the spraying gun and container are held during the spraying operation. This is achieved by the wall thickness changes 7a, 7b, . . . provided in the circumferential wall 7. Preferably the local outwardly and/or inwardly extending bulged out parts 7a, 7b, . . . are local wall thickenings. The preferred embodiment of FIG. 6 will during spraying of the paint essentially collapse in the height direction X-X′ of the container. Indeed, the wall parts with a lower wall thickness extending between the wall thickenings 7a, 7b, . . . will preferably collapse by which the bottom of the container 70 will move in the height direction X-X′. This is the preferred embodiment for spraying angles wherein the container may be held substantially vertical (with the height direction X-X′ more or less parallel to the direction of the gravity force). Another preferred embodiment is shown in FIG. 9 and has local outwardly and/or inwardly bulged out parts 7a, 7b, . . . which are divided over the circumference of the container and extend essentially parallel with the height direction X-X′ of the container. This container will during spraying of the paint preferably substantially collapse in the transversal direction Y-Y′ of the container. This may facilitate the outflow of the paint in other angular positions. Also a higher stability of the container in the height direction X-X′ is obtained, thereby allowing an easier filling of the container.

The preferred container as shown in FIG. 6 preferably is provided with a essentially transparent circumferential wall 7, whereby the local outwardly and/or inwardly bulged out parts 7a, 7b, . . . are divided over the height X-X′ of the circumferential wall 7 in such a way as to form a level indication for the volume of fluid, to be held in the container.

The lid 9 of the container 6 according to the invention is preferably manufactured from a stiff polymeric material, such as for instance high-density polyethylene, by means of injection molding. The lid has a central essentially cylindrically shaped part 20 with an opening 21, and a slant transversal part 22, which at the end develops into a raised circumferential wall 23. This circumferential wall 23 is provided with a gripping rim 24, and a part 10 serving to connect with the stiff raised rim 8 of the container 6. The gripping rim 24 facilitates grasping the lid 9 and turning it onto container 6. If desired the transversal part 22 is provided with gripping lips 25 to ease loosening and tightening of lid 9 onto the container 6. Gripping lips 25 extend for instance in the height direction along the gripping rim 24 of lid 9. A suitable lid for instance has two such gripping lips 25 positioned diametrically opposite to each other, as indicated in FIG. 2a. Part 10 has to cooperate with second attaching means 8 of the container, to be able to connect lid 9 and container 6 detachably but paint- or fluid tight to each other. A particularly preferred connection consists of a screw connection as indicated in FIG. 2.

A coupling piece 30 is applicable in opening 21 of lid 9, and is preferably manufactured from a suitable metal, preferably aluminum. As shown in FIG. 12 coupling piece 30 is provided with first and second end surfaces 31 en 32, positioned at a distance of each other, and a discharge opening 33, which extends between both end surfaces 31 en 32. A first part at end surface 31 height is provided with an external screw thread 34, which may cooperate with the internal screw thread of connection 11 of spraying gun 1. It is likewise possible to provide coupling piece 30 at this end with an internal screw thread, to cooperate with external screw thread of connection 11 of spraying gun 1. It is also possible to provide other connections between coupling piece 30 and spraying gun 1, such as for instance a bayonet connection. A second part at end surface 32 height has an external screw thread 35, which is able to cooperate with the internal screw thread 20 of lid 9. Coupling piece 30 is in normal use connected to lid 9, where after spraying gun 1 is attached to the other end of coupling piece 30. Meanwhile, it is also possible to connect coupling piece 30 first to spraying gun 1, and to subsequently attach the whole to lid 9.

Filling of the container 6 according to the invention is carried out by positioning the container 6 in upright position with the lid 9 uncoupled from container 6. In this way a large filling opening is created extending over substantially the complete diameter of the container 6. This allows filling the container with paint or other fluids very expediently and with large flow. As indicated for instance in FIGS. 6 and 9, container 6 may hereby be placed onto a surface completely free standing due to the presence on the container of stiff raised circumferential rim 8 and preferably also local wall thickenings 7a, 7b, . . . In order to fill it, it is also possible to suspend container 6 in a supporting container ring, which supports the lower rim 8c of stiff circumferential rim 8. To fill the container according to the invention, it is also possible to suspend it in a supporting beaker 50 (shown in FIG. 13) made of a suitable material such as for instance metal or a stiff polymer. After filling the flexible container 6 it is taken out of the supporting beaker 50 and connected through lid 9 to spraying gun 1.

1. Container suitable for holding paint or a similar fluid, to be sprayed with the aid of a spraying device, which container comprises a closed bottom and a circumferential wall, which at its under side is closed by the bottom and at its upper side comprises attachment means for detachably connecting to a lid, onto which container a spraying gun can be mounted, characterized in that, the container is to be mounted to a spraying gun in the absence of an external cup for receiving the container, in that the attachment means comprise a stiff raised rim, comprising first gripping means which are provided to cooperate with second gripping means present on the lid, the container is easily collapsible, in that the upper side of the circumferential wall of the container is bent into a tightening rim, in that the stiff raised rim comprises a first and a second part, which first part extends substantially parallel to the circumferential wall of the container, and which second part forms a tightening rim, which is provided to impinge onto the tightening rim of the circumferential wall of the container, in that the first gripping means for the lid are provided on an inner side of the first part of the stiff raised rim and in that the first gripping means of the stiff raised rim extend beyond the tightening rim of the circumferential wall in the connected position of the lid and the container.

2. Container according to claim 1, characterized in that, the circumferential wall of the container is provided with at least one local outwardly and/or inwardly bulged out wall part, whereby this part extends along an essentially closed circumferential contour in a plane substantially parallel to the bottom surface.

3. Container according to claim 2, characterized in that, the bulged out part has a wall thickness, which differs from the wall thickness of the rest of the circumferential wall.

4. Container according to claim 2, characterized in that, the container is essentially transparent and the local bulged wall parts are divided over the height of the circumferential wall such that they form a level indication for the volumetric amount of fluid, to be held in the container.

5. Container according to claim 1, characterized in that, the cooperating first and second gripping means form a screw-thread connection.

6. Container according to claim 1, characterized in that, the cooperating first and second gripping means form a bayonet-catch.

7. Container according to claim 1, characterized in that, the connection between the tightening rim of the stiff raised rim and the tightening rim of the circumferential wall fastened to each other in an un detachable way, preferably by means of welding or gluing.

8. Container according to claim 1, characterized in that, the tightening rim of the stiff raised rim and the tightening rim of the circumferential wall are detachably fastened to each other.

9. Container according to claim 1, characterized in that, the stiff raised rim is attached to at least part of the upper side of the circumferential wall over at least part of its surface by means of a welded connection.

10. Container according to claim 1, characterized in that a lower part of the second gripping means impinge on an upper part of the tightening rim and the first gripping means impinge upon a lower part of the tightening rim.

11. Container according to claim 1, characterized in that on an outer circumferential wall of the container, at a position below the tightening rim, at least one notch is provided at a distance from the tightening rim which is sufficient to accommodate between the tightening rim and the at least one notch, the second part of the stiff raised rim.

12. Assembly of a container according to claim 1, a lid connected thereto and provided with a connection for a spraying gun, and a spraying gun.
